(19) United States
(12) Patent Application Publication
(10) Pub. No.: US 2004/0121756 A1
(43) Pub. Date: Jun. 24, 2004

(54) Individual emergency tracking system

(76) Inventors: Robbin M. Griffin, Douglasville, GA (US); Bryan S. Allen, Mableton, GA (US)

Correspondence Address: Michael S. Neustel, Suite No. 4, 2534 South University Drive, Fargo, ND, 58103, US

(21) Appl. No.: 10/326,227

(22) Filed: Dec. 19, 2002

(51) Int. Cl. H04M 11/00; H04B 7/00; H04Q 7/20

(52) U.S. Cl. 455/404.2; 455/404.1; 455/456.1; 455/521

(57) ABSTRACT

An individual emergency tracking system for providing efficient notification to authorities and family that an individual is experiencing an emergency. The individual emergency tracking system includes a housing, a pair of bands attached to the housing for securing about a wrist, a control unit, a plurality of control switches for entering control codes, a microphone connected to the control unit, a camera connected to the control unit, a GPS unit connected to the control unit, and a transmitter unit connected to the control unit for transmitting an emergency signal to a central station. The emergency signal contains GPS data, audio data and video data relating to the location of the individual. Authorities and family are notified of the emergency via various communication means automatically.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to individual tracking devices and more specifically it relates to an individual emergency tracking system for providing efficient notification to authorities and family that an individual is experiencing an emergency.

2. Description of the Related Art

Individual tracking devices have been in use for years. Typically, individual tracking devices utilize global positioning system (GPS) technology and a radio signal transmitter for transmitting the geographic location of the individual to a receiver station. This technology is well known in the art and is taught in the below patents.

Examples of patented devices which may be related to the present invention include U.S. Pat. No. 5,742,233 to Hoffman et al.; U.S. Pat. No. 6,263,280 to Stingone, Jr.; U.S. Pat. No. 6,278,370 to Underwood; U.S. Pat. No. 5,771,001 to Cobb; U.S. Pat. No. 5,652,570 to Lepkofker; U.S. Pat. No. 4,673,936 to Kotoh; U.S. Pat. No. 6,333,694 to Pierce et al.; U.S. Pat. No. 6,362,778 to Neher; U.S. Pat. No. 6,377,170 to Chen; U.S. Pat. No. 6,388,612 to Neher; U.S. Pat. No. 6,236,319 to Pitzer et al.; U.S. Pat. No. 5,995,007 to Borja et al.; and U.S. Pat. No. 5,841,352 to Prakash.

While these devices may be suitable for the particular purpose to which they address, they are not as suitable for providing efficient notification to authorities and family that an individual is experiencing an emergency. The main problem with conventional individual locating devices is that they do not provide an efficient means for notifying family and authorities regarding the emergency.

In these respects, the individual emergency tracking system according to the present invention substantially departs from the conventional concepts and designs of the prior art, and in so doing provides an apparatus primarily developed for the purpose of providing efficient notification to authorities and family that an individual is experiencing an emergency.

### BRIEF SUMMARY OF THE INVENTION

In view of the foregoing disadvantages inherent in the known types of individual locating devices now present in the prior art, the present invention provides a new individual emergency tracking system construction wherein the same can be utilized for providing efficient notification to authorities and family that an individual is experiencing an emergency.

The general purpose of the present invention, which will be described subsequently in greater detail, is to provide a new individual emergency tracking system that has many of the advantages of the individual locating devices mentioned heretofore and many novel features that result in a new individual emergency tracking system which is not anticipated, rendered obvious, suggested, or even implied by any of the prior art individual locating devices, either alone or in any combination thereof.

To attain this, the present invention generally comprises a housing, a pair of bands attached to the housing for securing about a wrist, a control unit, a plurality of control switches for entering control codes, a microphone connected to the control unit, a camera connected to the control unit, a GPS unit connected to the control unit, and a transmitter unit connected to the control unit for transmitting an emergency signal to a central station. The emergency signal contains GPS data, audio data and video data relating to the location of the individual. Authorities and family are notified of the emergency via various communication means automatically.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an individual emergency tracking system that will overcome the shortcomings of the prior art devices.

A second object is to provide an individual emergency tracking system for providing efficient notification to authorities and family that an individual is experiencing an emergency.

Another object is to provide an individual emergency tracking system that is disguised as a conventional watch.

An additional object is to provide an individual emergency tracking system that provides parents, family, caregivers and guardians peace of mind regarding a child's safety and well being.

A further object is to provide an individual emergency tracking system that allows for the individual to easily select a panic switch when in danger and/or experiencing an emergency.

Another object is to provide an individual emergency tracking system that notifies authorities of the geographic location of the individual experiencing the emergency.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a top view of the present invention.

FIG. 2 is a front upper perspective view of the present invention.

FIG. 3 is a rear upper perspective view of the present invention.

FIG. 4 is a rear view of the present invention.

FIG. 5 is an upper perspective view of the present invention positioned about the wrist of a user.

FIG. 6 is an upper perspective view of the present invention positioned about the wrist of a user with the panic switch selected with the “alert” notice indicating that the invention has been activated.

FIG. 7 is an upper perspective view of the present invention being removed from the wrist of the user thereby automatically initiating the emergency signal after a finite period of time.

FIG. 8 is a block diagram of the electrical components of the present invention.

FIG. 9 is an illustration of the present invention with respect to GPS satellites and central station.

FIG. 10 is a flowchart illustrating the operation of the present invention.

### DETAILED DESCRIPTION OF THE INVENTION

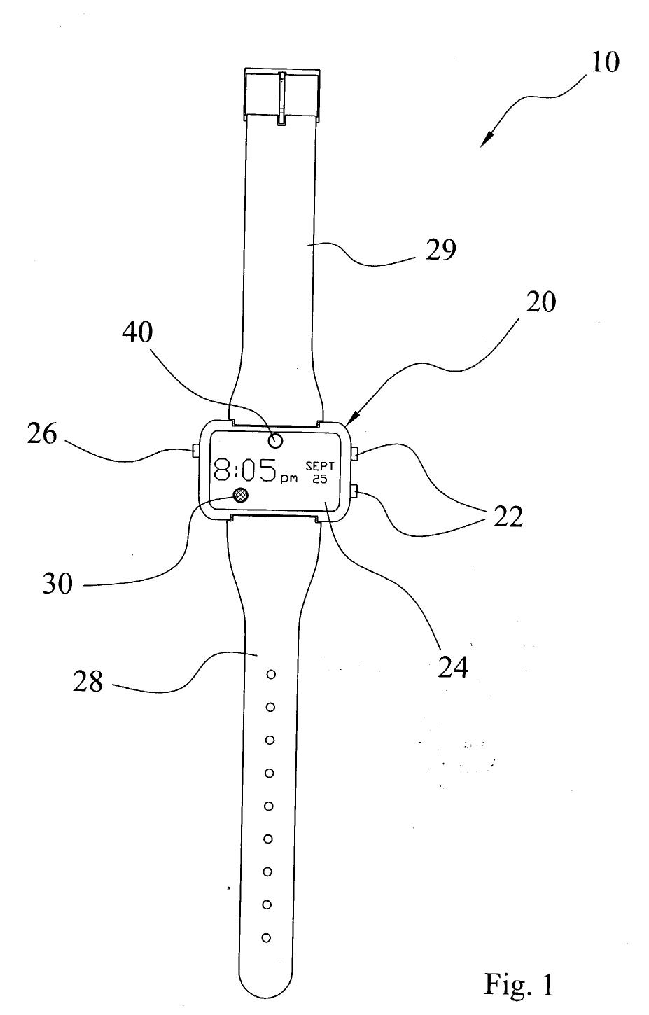

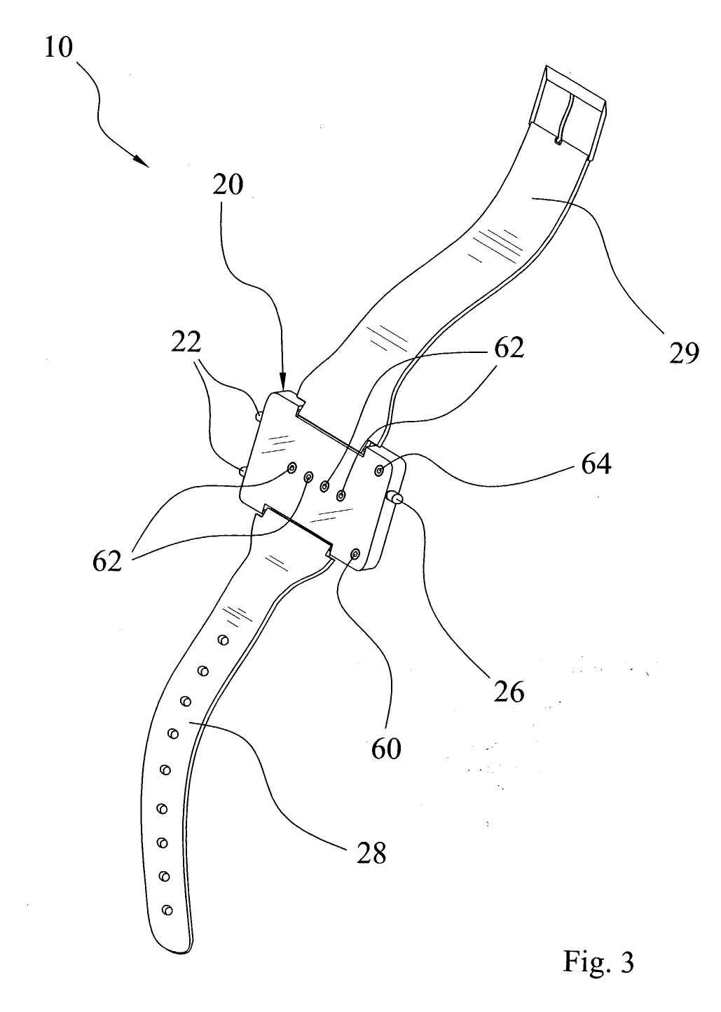

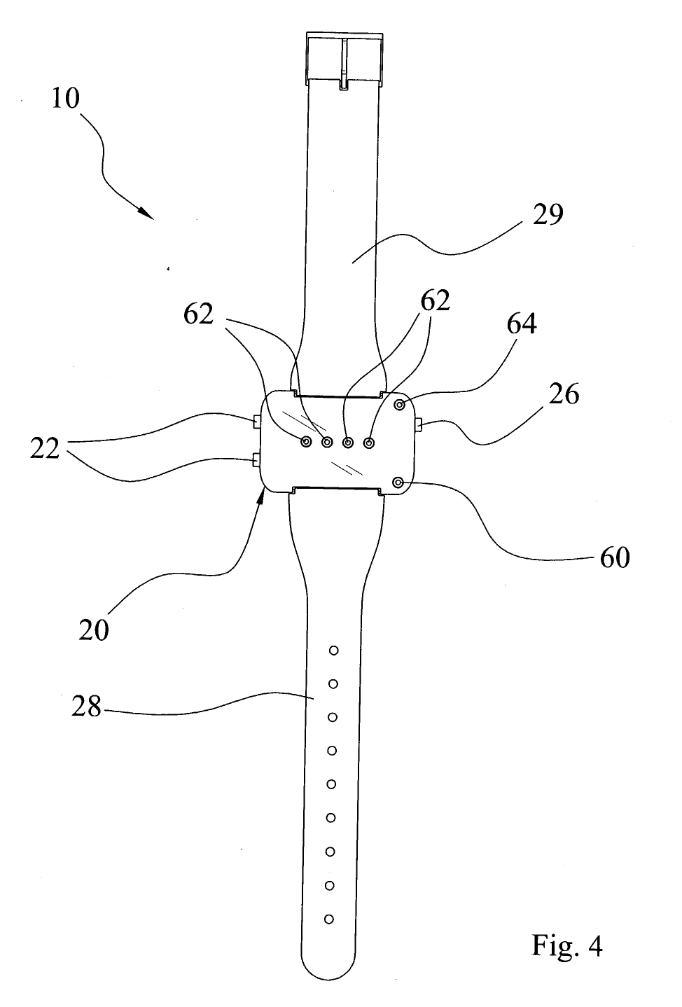

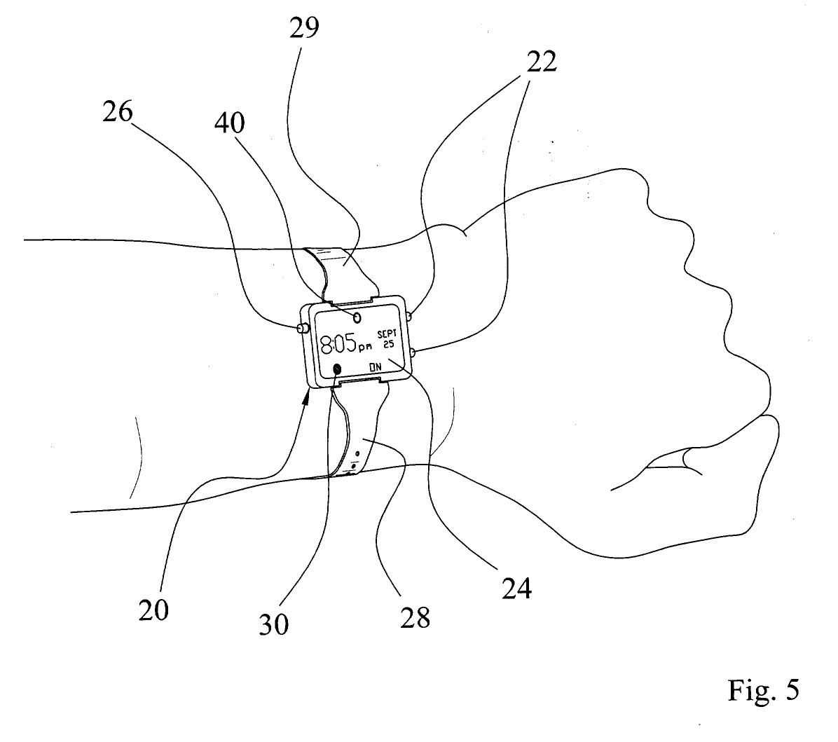

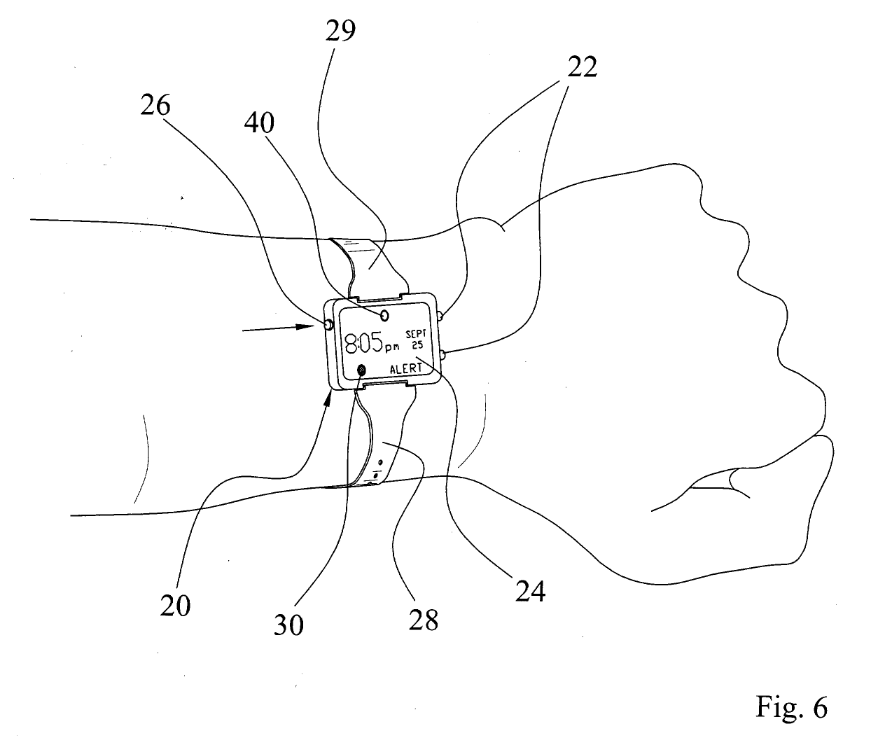

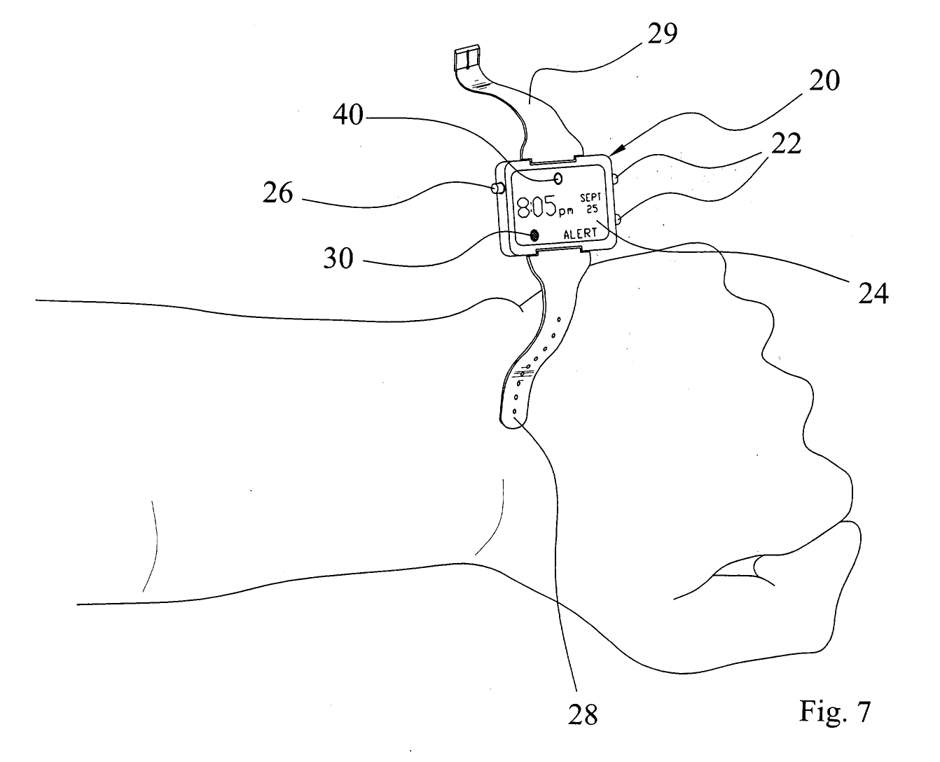

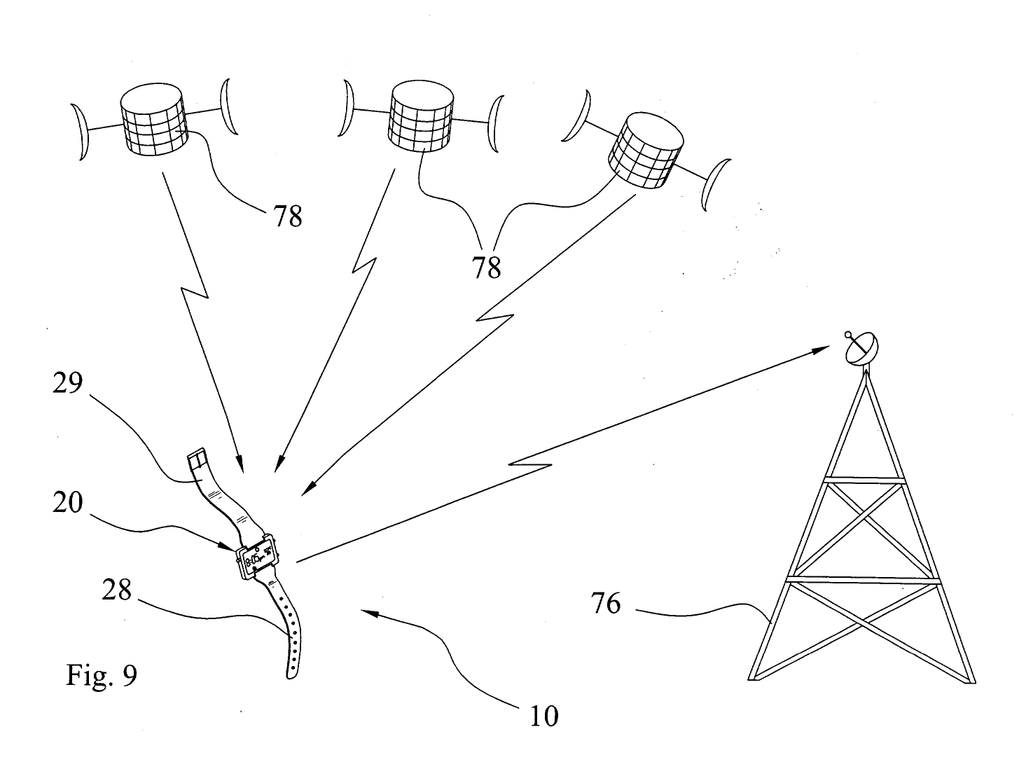

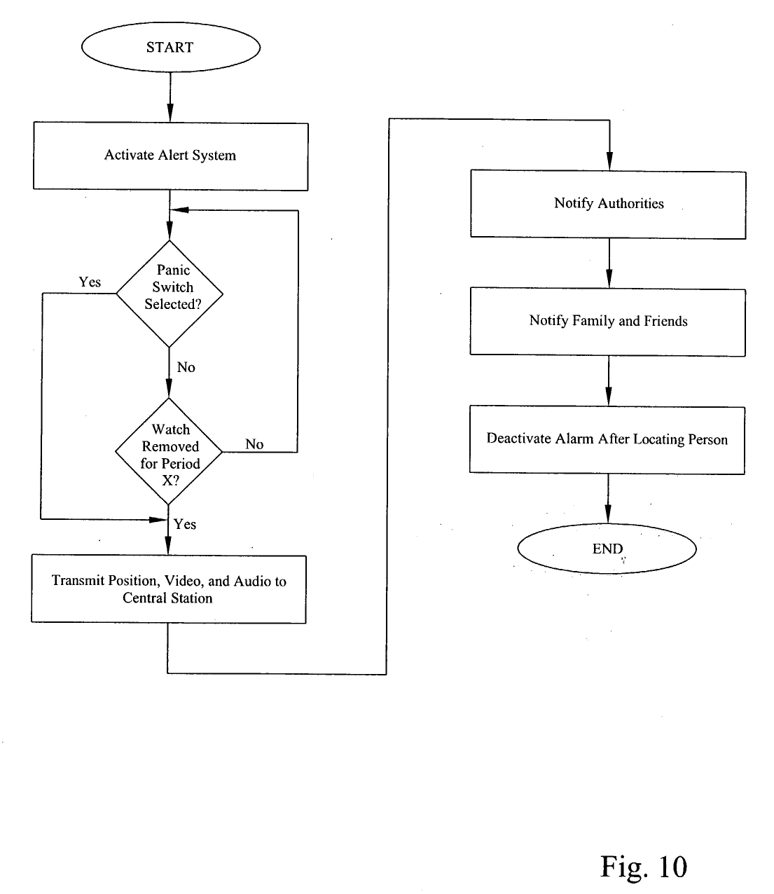

Turning now descriptively to the drawings, in which similar reference characters denote similar elements throughout the several views, FIGS. 1 through 10 illustrate an individual emergency tracking system 10, which comprises a housing 20, a pair of bands attached to the housing 20 for securing about a wrist, a control unit 70, a plurality of control switches for entering control codes, a microphone 30 connected to the control unit 70, a camera 40 connected to the control unit 70, a GPS unit 72 connected to the control unit 70, and a transmitter unit 74 connected to the control unit 70 for transmitting an emergency signal to a central station 76. The emergency signal contains GPS data, audio data and video data relating to the location of the individual. Authorities and family are notified of the emergency via various communication means automatically.

The housing 20 is comprised of a rigid structure for protecting the electrical components within the present invention. The housing 20 may be comprised of various materials such as but not limited to plastic, metal and composite. The housing 20 may have various shapes and sizes. However, the housing 20 preferably is shaped similar to a conventional watch structure in order to conceal the true identity of the present invention.

A first band 28 and a second band 29 are attached to the housing 20 for securing about the wrist of the individual. Various connection structures may be utilized for securing the first band 28 to the second band 29 in an adjustable manner. It can also be appreciated that a single band structure may be utilized for securing to the wrist of an individual. It should also be appreciated that the present invention is not limited to the application of resembling a watch but that other structure and situations are also suitable for the present invention.

The control unit 70 is positioned within the housing 20 and controls the operations and functions of the present invention. The control unit 70 is basically a computer unit which is capable of storing, sending and receiving data/commands. Control units are commonly utilized in various communication devices which are suitable for usage within the present invention. A portable power source is positioned within the housing 20 for providing electrical power to the control unit 70 and related devices.

A display screen 24 is positioned within the housing 20 for displaying the time, date, whether the invention is “on” and whether an “alert” signal has been transmitted. The display screen 24 is electrically connected to the control unit 70 and the display is controlled by the control unit 70. The display screen 24 may be comprised of any display unit capable of displaying characters such as but not limited to liquid crystal displays (LCD).

One or more auxiliary switches are positioned within the housing 20 and electrically connected to the control unit 70 for performing various functions. The auxiliary switches may be utilized to adjust the time, date or display configuration which is commonly known in the watch industry.

A panic switch 26 is positioned within a convenient location upon the housing 20 for providing efficient access to the individual when required. The panic switch 26 is electrically connected to the control unit 70 and indicates that the emergency signal should be transmitted to the nearest central station 76.

In addition to the panic switch 26 for controlling the sending of the emergency signal, a removal switch 21 is preferably positioned within the housing 20 or the bands 28, 29 for determining when the present invention is removed from the individual. If the present invention is removed for a period of time X without the deactivation code entered, the emergency signal is then automatically sent to the central station 76. The removal switch 21 may be comprised of various commonly utilized sensing devices such as a switch or light sensor positioned within the rear portion of the housing 20.

Within the back of the housing 20, a plurality of code switches 62 are positioned within that are electrically connected to the control unit 70. The code switches 62 allow for the entry of the activation/deactivation codes utilizing a specific sequence of entries or being depressed a number of times corresponding to the number of the code.

A code reset switch 60 is positioned within the housing 20 and electrically connected to the control unit 70 for indicating that the user desires to enter a new activation/deactivation code—the user must enter the current activation/deactivation code prior to entering the new code. After entering the desired code, the user then selects the code reset switch 60 at the end indicating that the code entry is completed.

A panic reset switch 64 is also positioned within the housing 20 and electrically connected to the control unit 70 for allowing the user to “deactivate” the present invention after being placed in an “alert” state. The user simply presses the panic reset switch 64 and then enters the deactivation code which then terminates the transmission of the emergency signal to the central station 76.

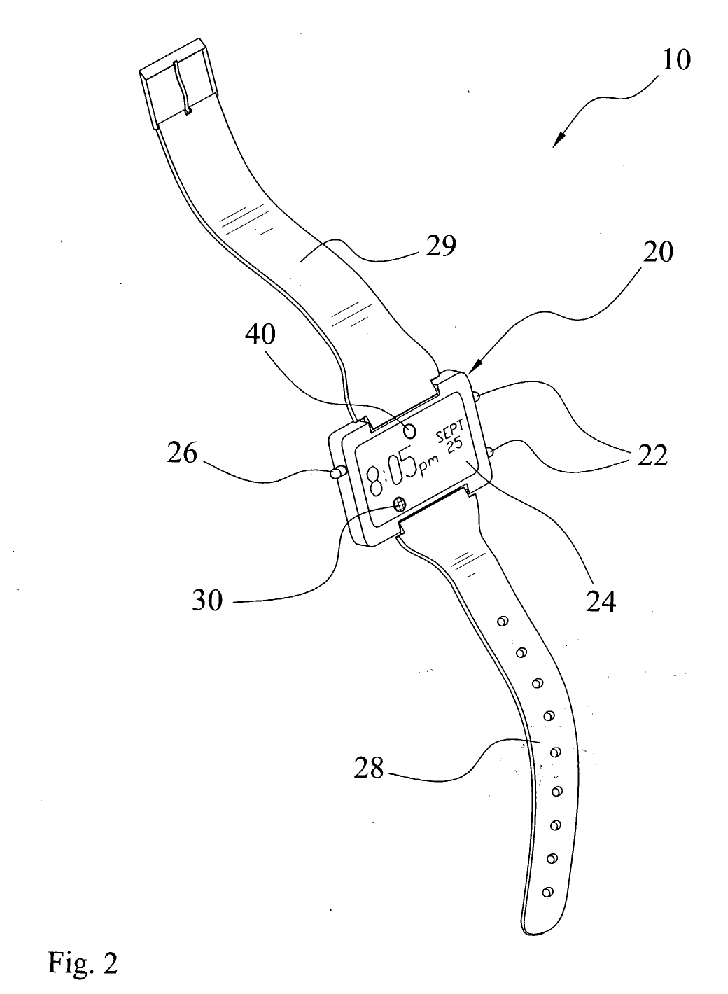

As shown in FIGS. 1 and 2 of the drawings, a microphone 30 is preferably positioned within the housing 20 and electrically connected to the control unit 70. The microphone 30 is designed for receiving audible sounds and voices near the individual which can then be transmitted to the central station 76 upon the emergency signal. The microphone 30 may be comprised of any well-known technology utilized.

As shown in FIGS. 1 and 2 of the drawings, a camera 40 of miniature size is also positioned within the housing 20 and electrically connected to the control unit 70. The camera 40 records digital images near the individual and then communicates the digital images to the control unit 70 for transmission to the central station 76 via the emergency signal.

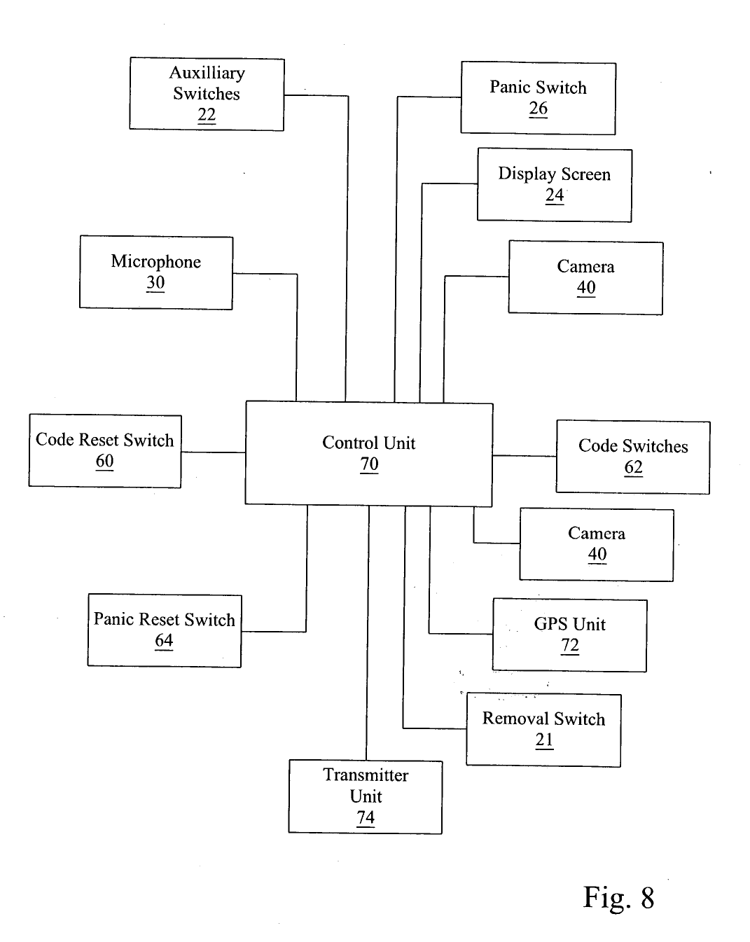

As shown in FIG. 8 of the drawings, a GPS unit 72 is electrically connected to the control unit 70 for determining the geographical location of the individual based upon GPS data signals received from GPS satellites 78. The GPS unit 72 may be comprised of any well-known GPS technology.

A transmitter unit 74 is electrically connected to the control unit 70 and transmits the emergency signal via a radio signal to the central station 76 as illustrated in FIG. 8 of the drawings. The emergency signal is capable of transmitting the GPS data, audio data, and video data, along with alert data such as the identity of the individual and related information such as the individuals that should be notified about the incident. The transmitter unit 74 is preferably capable of transmitting the emergency signal a significant distance so as to be received by at least one central station 76.

It can be appreciated that it is desirable to have a plurality of central stations 76 located throughout a geographical region so as to adequately receive the emergency signal. The central stations 76 have a receiver within that is capable of receiving the emergency signal and converting the data to a readable format.

The central station 76 also preferably notifies authorities, friends, relatives and other specified individuals of the situation via pager, telephone, cell phone, and electronic mail. The GPS position data, audio data and video data may be viewed at the central station 76 to assist authorities in locating the individual and also understand the specific situation the individual is involved in.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An individual emergency tracking system, comprising:
a housing;
a control unit positioned within said housing;
a display in communication with said control unit;
a plurality of code switches in communication with said control unit for entering an activation/deactivation code;
a GPS unit in communication with said control unit;
a transmitter unit in communication with said control unit for transmitting an emergency signal to a central station containing GPS data and identification data; and
a panic switch in communication with said control unit for indicating a panic situation.

2. The individual emergency tracking system of claim 1, wherein said identification data includes communication data for individuals to be notified about the situation.

3. The individual emergency tracking system of claim 1, including a microphone in communication with said control unit.

4. The individual emergency tracking system of claim 1, including a camera in communication with said control unit.

5. The individual emergency tracking system of claim 1, including a microphone and a camera in communication with said control unit, wherein said emergency signal carries audio data and video data.

6. The individual emergency tracking system of claim 1, including a removal switch in communication with said control unit for determining when said housing is removed from an individual.

7. The individual emergency tracking system of claim 6, wherein said control unit determines whether a period of time X has passed since the initial removal of the housing and after said period of time X activates alert system.

8. The individual emergency tracking system of claim 1, wherein said identification data includes electronic mail address data for individuals to be notified about the situation.

9. The individual emergency tracking system of claim 1, wherein said identification data includes telephone number data for individuals to be notified about the situation.

10. The individual emergency tracking system of claim 1, wherein said identification data includes pager number data for individuals to be notified about the situation.

11. The individual emergency tracking system of claim 1, including a code reset switch in communication with said control unit for controlling the entering of code information.

12. The individual emergency tracking system of claim 1, including a panic reset switch in communication with said control unit for allowing deactivation after entering of the deactivation code.

13. The individual emergency tracking system of claim 1, wherein said code switches are positioned within a rear portion of said housing.

14. The individual emergency tracking system of claim 1, including at least one band attached to said housing for securing to an individual.

15. A method of operating an emergency unit, comprising:
receiving an emergency signal from a transmitter unit, wherein said emergency signal contains GPS location data and individual identification data; and
communicating with individuals within said individual identification data regarding the emergency situation.

16. The method of operating said emergency unit of claim 15, wherein said communicating with individuals is comprised of a transmitting electronic mail to said individuals.

17. The method of operating said emergency unit of claim 15, wherein said communicating with individuals is comprised of a transmitting a digital voice message to said individuals.

18. The method of operating said emergency unit of claim 15, wherein said communicating with individuals is comprised of a transmitting a pager message to said individuals.

19. The method of operating said emergency unit of claim 15, including deactivating said emergency signal by entering a deactivation code into said emergency unit.
